(19) United States
(12) Patent Application Publication
(10) Pub. No.: US 2010/0109382 A1
(43) Pub. Date: May 6, 2010

(54) LIGHTWEIGHT COMPONENT IN HYBRID CONSTRUCTION

(75) Inventors: Ulrich Dajek, Leverkusen (DE); Alexander Radeck, Hong Kong (CN)

Correspondence Address: GERSTENZANG, WILLIAM C.;NORRIS MCLAUGHLIN & MARCUS, PA, 875 THIRD AVE, 8TH FLOOR, NEW YORK, NY, 10022, US

(73) Assignee: LANXESS DEUTSCHLAND GMBH, LEVERKUSEN (DE)

(21) Appl. No.: 12/526,106

(22) PCT Filed: Jan. 30, 2008
(86) PCT No.: PCT/EP2008/051129

§ 371 Date: Jan. 5, 2010

(30) Foreign Application Priority Data
Feb. 9, 2007 (DE) 10 2007 006 493.6

(51) Int. Cl. B62D 25/08; B32B 7/04; B32B 3/10; B29C 65/00; B29C 49/00; B29C 47/02; B29C 45/14; B29C 43/28

(52) U.S. Cl. 296/193.04; 428/198; 264/259; 264/510

(57) ABSTRACT

Lightweight components of hybrid design, also termed hybrid component or hollow-chamber lightweight component, formed of a shell-type parent body which is reinforced by thermoplastics and is suitable for the transmission of high mechanical loads, where the thermoplastic is linear, semicrystalline polyamide, in combination with at least one filler and with at least one elastomeric modifier.

The present invention relates to lightweight components of hybrid design, also termed hybrid component or hollow-chamber lightweight component, composed of a shell-type parent body which is reinforced by means of thermoplastics and is suitable for the transmission of high mechanical loads, where the thermoplastic is an unbranched linear, semicrystalline polyamide, in combination with at least one elastomeric modifier and with at least one filler. In one preferred embodiment, the hybrid component is a component which, in operation, can be subjected to mechanical and also thermal load. Components which for the purposes of the present invention are subjected to thermal load withstand temperatures of at least 150° C. At temperatures of 150° C. and above, the resistance of the material to creep is sufficient that it can also simultaneously withstand mechanical loads. In order to ensure that the material has adequate creep resistance when it is subjected not only to thermal load but also to mechanical load, a temperature of 190° C. should generally not be exceeded.

For the purposes of the present invention, therefore, a component subjected to mechanical load is not generally exposed to temperatures above 190° C.

These lightweight components, appropriately designed, are used for vehicle parts, in load-bearing elements of office machinery, household machinery, or other machinery, or in structural elements for decorative purposes, or the like. The parts produced in vehicle construction can preferably be front ends, headlamp frames, pedestrian-protection beam, specialized slam panels for engine hoods or luggage-compartment lids, front roof arches, rear roof arches, roof frames, roof modules (entire roof), sliding-roof support parts, dashboard support parts (cross car beam), steering column retainers, fire wall, pedals, pedal blocks, gear-shift blocks, A, B, or C columns, B-column modules, longitudinal members, jointing elements for the connection of longitudinal members and B columns, jointing elements for the connection of A column and transverse member, jointing elements for the connection of A column, transverse member, and longitudinal member, and of transverse members, and for wheel surrounds, wheel-surround modules, crash boxes, rear ends, spare-wheel recesses, engine hoods, engine covers, engine oil sumps, gearbox oil sumps, oil modules, water-tank assembly, engine-rigidity systems (front-end rigidity system), chassis components, vehicle floor, door sills, door-sill-reinforcement systems, floor reinforcement systems, seat-reinforcement systems, transverse seat members, tailgates, frames, seat structures, backrests, seat shells, seat backrests with or without integrated safety belt, parcel shelves composed of lightweight components.

A feature of lightweight components of hybrid design, hereinafter also termed hybrid components, is interlock bonding of a shell-type parent body mostly composed of metal to a plastics part introduced into the same or cladded onto the same.

DE-A 27 50 982 discloses a non-releasable connection involving two or more parts, preferably composed of metal, where the connection is composed of plastic and is produced in a mold which accepts the parts to be connected, for example by the injection-molding process. EP-A 0 370 342 discloses a lightweight component of hybrid design composed of a shell-type parent body whose internal space has reinforcing ribs securely connected to the parent body, in that the reinforcing ribs are composed of molded-on plastic and their connection to the parent body takes place at discrete connection sites by way of perforations in the parent body, through which the plastic extends and extends across the areas of the perforations, and a secure interlock bond is achieved. EP-A 0 995 668 supplements this principle in that the hollow-chamber lightweight component is additionally provided with a cover plate or cover shell composed of plastic. However, it is also possible to conceive of a cover plate composed of other materials, such as metal.

WO 2002/068257 discloses what are known as integrated structures composed of metal and plastic with the description of a number of fastening means in order to provide secure connection of the two components to one another. WO 2004/071741 discloses the alternative procedure, namely using two operations, beginning by overmolding the metal part with plastic in such a way that the plastic passes through openings in the metal part and leaves flash material on the other side, where an additional conversion operation is required before this material leads to a secure interlock bond. EP 1 294 552 B1 discloses that, for the production of a hybrid component, it is possible that the metal core has been not completely, but only sectionally, overmolded by the plastic, to give a secure interlock bond. WO 2004/011315 discloses a further variant in which the metal part provides, both above and below, openings for the secure interlock bond with the overmolded plastic. WO 2001/38063 describes a composite plastics part composed of at least two sheet-like workpieces of different material, for example plastic and metal, or of different metals or plastics, where the workpieces have been connected to one another in their peripheral region, and the connection is composed of molded-on thermoplastic. EP 1 223 032 A2 discloses a sheet-type lightweight component of hybrid design. U.S. Pat. No. 6,761,187 B1 discloses a hybrid component in the form of a channel or of a tube with integrated closure composed of a thermoplastic. DE 195 43 324 A1 discloses how the metal component for use as hybrid component can be prepared in order to achieve a secure interlock bond with the thermoplastic. EP 1 340 668 A2 or EP 1 300 325 A2 provides the possibility of ribbing not only within the metal part for reinforcement but also outside of the same.

It was quickly recognized that lightweight components of hybrid design have excellent suitability wherever high stability, high energy absorption in the event of a crash, and weight saving were important, i.e. in the construction of motor vehicles, for example. EP 0 679 565 B1 discloses the front end of a motor vehicle with at least one rigid transverse bar which extends over most of the length of the front end, with at least one supporting part composed of plastic, cast onto the end region of the rigid transverse bar. EP 1 032 526 B1 discloses a load-bearing structure for the front module of a motor vehicle composed of a steel sheet parent body, of an unreinforced amorphous thermoplastic material, of a glass-fiber-reinforced thermoplastic, and also of a rib structure composed of, for example, polyamide. DE 100 53 840 A1 discloses a bumper system or energy-absorber element composed of oppositely arranged metal sheets and connection ribs composed of thermoplastic or of thermoset. WO 2001/40009 discloses the use of hybrid technology in brake pedals, clutch pedals or accelerator pedals of motor vehicles. EP 1 211 164 B1 in turn describes the support structure for a motor vehicle radiator arrangement, using a hybrid structure. DE 101 50 061 A1 discloses the lock transverse member in the vehicle front module of hybrid design. U.S. Pat. No. 6,688,680 B1 describes a transverse member of hybrid design in a vehicle. EP 1 380 493 A2 gives another example of a front end panel of a motor vehicle, but here the material is not injected around all of the metal part but takes the form of webs bracketing the same. Lightweight components of hybrid design can be used not only for front ends or pedals but also anywhere in the bodywork of a vehicle. Examples are provided for this purpose by DE 100 18 186 B4 for a vehicle door with door casing, EP 1 232 935 A1 for the actual bodywork of a vehicle and DE 102 21 709 A1for the load-bearing elements of motor vehicles.

In contrast to the components described in the prior art, a generator of an automobile has components subject to mechanical and thermal load for the purposes of the present invention. The generator is driven by the running engine and is thus subjected to mechanical load. The usual method of drive in an automobile uses a drive belt (e.g. a multiribbed V-belt or a flat V-belt). The automobile section has also recently started to use designs in which, as is the case with many wheels within the engine, the generator is directly driven from the crankshaft.

The rotation rate of the rotor in generators is often at least 20 000 rpm. The mechanical stresses arising here are correspondingly high. Within a generator there are high temperatures caused inter alia by friction.

The casing of a generator here is regularly exposed to temperatures of from 150° C. to 190° C. and to mechanical load. For reasons of cost, this casing is preferably manufactured from metal, since metal withstands the mechanical and thermal loads. The casing is generally composed of two shells, provided with a bearing for the axis of the rotor. In many instances, the shells also have ventilation slits. At least one shell also generally has fastening elements to permit fastening of the generator within the engine compartment of an automobile. A casing also generally has other functional elements, of relatively complicated design.

The components of an electric motor are comparable with a generator in having regular exposure to mechanical and thermal loads, for comparable reasons.

Valve covers in an automobile are another example of components for the purposes of the present invention. The valve cover, also termed “cylinder head cover” forms the uppermost boundary of a (vertical) internal combustion engine.

It conceals the upper actuating elements of the valve operating mechanism and prevents the escape of the lubricating oil into the environment, and also prevents ingress of air into the engine; modern engines have a slightly subatmospheric internal pressure, in order to prevent combustion gases and vapors from passing out of the engine into the environment. The valve cover also very often comprises the filler aperture for the engine oil, together with the closure cap.

If the valve operating mechanism has an overhead camshaft and this is driven by a chain (all Daimler-Benz engines, many BMW engines, some Audi engines, etc.), the valve cover also comprises the camshaft sprockets.

There is often a U-shaped plastics gasket sealing the valve cover with respect to the cylinder head. For decades, the valve cover was sealed using a peripheral gasket of cork or of molded thermoset resin, and this was also the case with the two valve covers of a VW Beetle engine. For connecting the valve cover to the cylinder head there are generally a large number of bolts which are screwed through the periphery of the valve cover and through the gasket into the cylinder head. This design disadvantageously requires a large number of bolts to produce a leakproof connection between the valve cover and the cylinder head. In order to reduce the number of bolts, in a modern embodiment the bolts are passed through the center of the cover. This embodiment has none of the lateral bolts which pass through the gasket. This method can markedly reduce the number of bolts needed. However, the material of the valve cover is subjected to markedly greater mechanical load in this embodiment. It has to be particularly resistant to creep, in order to maintain the seal for a long period. The valve cover must also withstand the prevailing operating temperatures which are generally 150° C. Other examples of components which during operation are at least subjected to mechanical load for the purposes of the present invention are assembly holders in an automobile. By way of example, this type of assembly holder is used to secure a generator in the interior of the automobile. The generator is subjected to mechanical load by the belt drive, and this mechanical load is therefore transferred to the assembly holder. If the arrangement has this type of assembly holder in the vicinity of hot components, it is also subject to thermal load.

When components are subjected to mechanical and thermal load for the purposes of the present invention, the material selected for the production of the components is generally metal. This material withstands the mechanical and thermal loads.

Although there are plastics which would likewise withstand the mechanical and thermal loads in comparable fashion, these are expensive specialty plastics and are not used for reasons of cost.

As revealed by the prior art, hybrid components can be used for a large number of applications. Hybrid components intended for uses including end plates for generators or electric motors, or else as valve covers, are composed of a shell-type parent body reinforced by means of thermoplastics. The thermoplastic materials generally comprise fillers, preferably fibers, which reinforce the thermoplastics. However, a disadvantage of these reinforcing fillers is that they adversely affect the flowability of the thermoplastic, the result being that the latter cannot be processed as desired to give a hybrid component, or that components produced therefrom cannot be subjected to mechanical or thermal load in the sense mentioned in the introduction.

It was therefore the object of the present invention to produce hollow-chamber lightweight components which firstly have the advantages known from the prior art, such as high buckling resistance, high torsional stability, and relatively high strength, but which moreover feature relatively low weight and relatively low mold temperatures during their production, where the viscosity of the polyamide polycondensate compositions is lowered via use of additives in the polymer melt, without any need here to accept the sort of losses in properties such as impact resistance and hydrolysis resistance that occur when low-viscosity linear polymer resins or additives known from the literature are used, but while simultaneously permitting use of up to 60% by weight of filler, without any need to accept losses in the mechanical and/or thermal properties of moldings produced therefrom. In terms of stiffness and ultimate tensile strength, the intention was that ideally there be no significant difference in polyamide compositions of this kind from polyamide polycondensate compositions not using additives, thus permitting problem-free replacement of the materials for plastics structures based on polyamide, and thus providing optimized use in hybrid components.

The object is achieved in that the present invention provides lightweight components composed of a shell-type parent body whose external and/or internal space has reinforcing structures securely connected to the parent body and composed of molded-on thermoplastics, and having connection to the parent body at discrete connection sites, characterized in that polymer compositions are used comprising
A) from 55 to 10 parts by weight, preferably from 50 to 30 parts by weight, particularly preferably from 45 to 32 parts by weight, of a linear, unbranched, semicrystalline thermoplastic polyamide,
B) from 48 to 80 parts by weight, preferably from 50 to 75 parts by weight, particularly preferably from 55 to 70 parts by weight, of at least one filler and
C) from 0.01 to 10 parts by weight, preferably from 0.25 to 6 parts by weight, particularly preferably from 1.0 to 4 parts by weight, of at least one elastomeric modifier.

However, the present invention also provides a process for the production of a lightweight component in hybrid form whose external and/or internal space has reinforcing structures securely connected to the parent body and composed of a molded-on thermoplastic, and having connection to the parent body at discrete connection sites, characterized in that the polymer molding compositions comprising
A) from 55 to 10 parts by weight of a linear, unbranched, semicrystalline polyamide,
B) from 48 to 80 parts by weight of at least one filler and
C) from 0.01 to 10 parts by weight of at least one elastomeric modifier are processed via shaping processes in a shaping mold.

The processing of the polymer molding compositions to give the lightweight components of the invention, of hybrid design, takes place via shaping processes for thermoplastics, preferably via injection molding, melt extrusion, compression molding, stamping or blow molding. According to the invention, linear, unbranched, semicrystalline, thermoplastic polyamides have best suitability for the use as hybrid component. However, it is also conceivable to use alternative plastics, such as polyesters, polyethylene, polypropylene, etc.

The person skilled in the art is aware of various processes for the production of polyamides. The effects to be achieved are equally apparent with any of the variations known from the abovementioned prior art for use of hybrid technology, irrespective of whether the plastics part encapsulates the metal part completely or, as in the case of EP 1 380 493 A2, merely forms a web around it, and irrespective of whether the plastics part is subsequently incorporated by adhesion or connected by way of example by a laser to the metal part, or whether, as in WO 2004/071741, the plastics part and the metal part obtain the secure interlock bond in an additional operation. The effects to be achieved are likewise apparent in components of hybrid design which are subject to either mechanical stress or else to thermal stress or else to both mechanical and thermal stress, examples being end plates of generators or electric motors.

The technology for production of components of hybrid design can also be termed a method for weight reduction. The present invention therefore also provides a method for reducing the weight of components, preferably of vehicles of any kind, characterized in that lightweight components are produced, composed of a shell-type parent body whose external and/or internal space has reinforcing structures securely connected to the parent body and composed of molded-on thermoplastics, and having connection to the parent body at discrete connection sites, where the polymer molding compositions to be used comprise
A) from 55 to 10 parts by weight of a linear, unbranched, semicrystalline polyamide,
B) from 48 to 80 parts by weight of at least one filler and
C) from 0.01 to 10 parts by weight of at least one elastomeric modifier.

According to the invention, polyamides A) to be used with particular preference as component A) are linear, unbranched, semicrystalline polyamides which can be produced starting from diamines and dicarboxylic acids and/or lactams having at least 5 ring members, or from corresponding amino acids.

Starting materials that can be used for this purpose are aliphatic and/or aromatic dicarboxylic acids, such as adipic acid, 2,2,4- and 2,4,4-trimethyladipic acid, azelaic acid, sebacic acid, isophthalic acid, terephthalic acid, and aliphatic and/or aromatic diamines, e.g. tetramethylene-diamine, hexamethylenediamine, 1,9-nonanediamine, 2,2,4- and 2,4,4-trimethyl-hexamethylenediamine, the isomeric diaminodicyclohexylmethanes, diaminodicyclo-hexylpropanes, bisaminomethylcyclohexane, phenylenediamines, xylylenediamines, amino-carboxylic acids, e.g. aminocaproic acid, and the corresponding lactams. Copolyamides composed of a plurality of the monomers mentioned are included.

Polyamides preferred according to the invention are prepared from caprolactams, very particularly preferably from ε-caprolactam, and also most of the compounding materials based on PA6, on PA66, and on other aliphatic and/or aromatic polyamides and, respectively, copolyamides, where there are from 3 to 11 methylene groups for every polyamide group in the polymer chain.

Fillers to be used according to the invention as component B) are preferably fibrous reinforcing materials, in particular chopped glass fibers.

Particularly when glass fibers are used, it is possible to use not only silanes but also polymer dispersions, film-formers, branching agents, and/or glass fiber-processing aids.

The glass fibers to be used with particular preference according to the invention, the diameter of which is generally from 7 to 18 μm, preferably from 9 to 15 μm, are added in the form of continuous-filament fibers or in the form of chopped or ground glass fibers. The fibers can have been equipped with a suitable size system and/or with a coupling agent or coupling-agent system, e.g. one based on silane.

By virtue of the processing to give the molding composition or molding, the length of the glass fibers in the molding composition or in the molding can be markedly shorter than the length of the glass fibers generally used in the production of the molding composition.

The elastomeric modifiers to be used according to the invention as component C) comprise one or more graft polymers of
C1 from 5 to 95% by weight, preferably from 30 to 90% by weight, of at least one vinyl monomer on
C2 from 95 to 5% by weight of preferably from 70 to 10% by weight, of one or more graft bases with glass transition temperatures <10° C., preferably <0° C., particularly preferably <−0° C.

The median particle size (d50 value) of the graft base C2 is generally from 0.05 to 10 μm, preferably from 0.5 to 5 μm, particularly preferably from 0.2 to 1 μm.

Monomers C.1 are preferably mixtures composed of
C.1.1 from 50 to 99% by weight of vinylaromatic and/or of ring-substituted vinylaromatics, preferably styrene, α-methylstyrene, p-methylstyrene, p-chlorostyrene, and/or C1-C8-alkyl methacrylate, preferably methyl methacrylate or ethyl methacrylate and
C.1.2 from 1 to 50% by weight of vinyl cyanides, preferably unsaturated nitriles, in particular acrylonitrile and methacrylonitrile and/or C1-C8-alkyl (meth)acrylate, preferably methyl methacrylate, n-butyl acrylate, tert-butyl acrylate, and/or derivatives, preferably anhydrides and imides, of unsaturated carboxylic acids, preferably maleic anhydride and N-phenylmaleimide.

Particularly preferred monomers C.1.1 are those selected from at least one of the following monomers: styrene, α-methylstyrene and methyl methacrylate, and preferred monomers C.1.2 are those selected from at least one of the following monomers: acrylonitrile, maleic anhydride and methyl methacrylate.

Very particularly preferred monomers are C.1.1 styrene and C.1.2 acrylonitrile.

Graft bases C.2 suitable for the graft polymers to be used in the elastomeric modifiers C) are diene rubbers, EP(D)M rubbers, i.e. rubbers based on ethylene/propylene, other suitable graft bases being, if appropriate, diene, acrylate rubbers, polyurethane rubbers, silicone rubbers, chloroprene and ethylene/vinyl acetate rubbers.

Preferred graft bases C.2 are diene rubbers (e.g. those based on butadiene, isoprene, etc.) or diene-rubber mixtures or copolymers of diene rubbers or of mixtures of these with other copolymerizable monomers (e.g. according to C.1.1 and C.1.2), with the proviso that the glass transition temperature of component C.2 is <10° C., preferably <0° C., particularly preferably <−10° C.

Other preferred graft bases C.2 are the ABS polymers (emulsion ABS, bulk ABS and suspension ABS) described by way of example in DE-A 2 035 390 (=U.S. Pat. No. 3,644,574) or in DE-A 2 248 242 (=GB-A 1 409 275) or in Ullmann, Enzyklopädie der Technischen Chemie [Encyclopedia of Industrial Chemistry], Volume 19 (1980), pages 280 ff. (ABS=acrylonitrile-butadiene-styrene).

The gel content of the graft base C.2 is preferably at least 30% by weight, particularly preferably at least 40% by weight (measured in toluene).

The elastomeric modifiers C) are produced via free-radical polymerization, e.g. via emulsion polymerization, suspension polymerization, solution polymerization or bulk polymerization, preferably via emulsion polymerization or bulk polymerization.

Suitable acrylate rubbers are based on graft bases C2 which preferably comprise polymers composed of alkyl acrylates, if appropriate having up to 40% by weight, based on C.2, of other polymerizable, ethylenically unsaturated monomers. Among the preferred polymerizable acrylates are C1-C8-alkyl esters, such as methyl, ethyl, butyl, n-octyl and 2-ethylhexyl esters; haloalkyl esters, preferably halo-C1-C8-alkyl esters, such as chloroethyl acrylate, and also mixtures of said monomers.

For crosslinking, it is possible to copolymerize monomers having more than one polymerizable double bond. Preferred examples of crosslinking monomers are esters of unsaturated monocarboxylic acids having from 3 to 8 carbon atoms and of unsaturated monohydric alcohols having from 3 to 12 carbon atoms, or of saturated polyols having from 2 to 4 OH groups and having from 2 to 20 carbon atoms, e.g. ethylene glycol dimethacrylate, allyl methacrylate; polyunsaturated heterocyclic compounds, e.g. trivinyl cyanurate and triallyl cyanurate; polyfunctional vinyl compounds, such as di- and trivinylbenzenes; and also triallyl phosphate and diallyl phthalate.

Preferred crosslinking monomers are allyl methacrylate, ethylene glycol dimethacrylate, diallyl phthalate and heterocyclic compounds which have at least 3 ethylenically unsaturated groups.

Particularly preferred crosslinking monomers are the cyclic monomers triallyl cyanurate, triallyl isocyanurate, triacryloylhexahydro-s-triazine, and triallylbenzenes. The amount of the crosslinking monomers is preferably from 0.02 to 5% by weight, in particular from 0.05 to 2% by weight, based on the graft base C.2.

In the case of cyclic crosslinking monomers having at least 3 ethylenically unsaturated groups, it is advantageous to restrict the amount to less than 1% by weight of the graft base C.2.

Examples of preferred “other” polymerizable, ethylenically unsaturated monomers which can serve alongside the acrylates, if appropriate, for the production of the graft base C.2 are acrylonitrile, styrene, α-methylstyrene, acrylamides, vinyl C1-C6-alkyl ethers, methyl methacrylate, and butadiene. Preferred acrylate rubbers as graft base C.2 are emulsion polymers whose gel content is at least 60% by weight.

Other suitable graft bases according to C.2 are the silicone rubbers described in DE-A 3 704 657 (=U.S. Pat. No. 4,859,740), DE-A 3 704 655 (=U.S. Pat. No. 4,861,831), DE-A 3 631 540 (=U.S. Pat. No. 4,806,593) and DE-A 3 631 539 (=U.S. Pat. No. 4,812,515), these having sites active in grafting.

Alongside elastomeric modifiers based on graft polymers, it is equally possible to use, as component C), elastomeric modifiers which are not based on graft polymers and which have glass transition temperatures <10° C., preferably <0° C., particularly preferably <−20° C. Examples of these can be elastomers having a block copolymer structure. Other examples of these can be thermoplastically fusible elastomers. Preferred examples that may be mentioned here are EPM rubbers, EPDM rubbers and/or SEBS rubbers.

In an alternative preferred embodiment, the polyamide molding compositions to be used for the production of the components of the invention, based on hybrid design, can also, if appropriate, comprise, in addition to components A), B) and C),
D) from 0.001 to 30 parts by weight, preferably from 5 to 25 parts by weight, particularly preferably from 9 to 19 parts by weight, of at least one flame-retardant additive.

The flame retardant of component D) can comprise commercially available organic halogen compounds with synergists or can comprise commercially available organic nitrogen compounds or can comprise organic/inorganic phosphorus compounds alone or in a mixture. It is also possible to use flame-retardant mineral additives such as magnesium hydroxide or Ca Mg carbonate hydrates (DE-A 4 236 122 (=CA 210 9024 A1)). It is also possible to use salts of aliphatic or aromatic sulphonic acids. Examples that may be mentioned of halogen-containing, in particular brominated and chlorinated, compounds are: ethylene-1,2-bistetrabromophthalimide, epoxidized tetrabromobisphenol A resin, tetrabromobisphenol A oligocarbonate, tetrachlorobisphenol A oligo-carbonate, pentabromopolyacrylate, brominated polystyrene and decabromodiphenyl ether. Examples of suitable organic phosphorus compounds are the phosphorus compounds according to WO-A 98/17720 (=U.S. Pat. No. 6,538,024), e.g. triphenyl phosphate (TPP), resorcinol bis(diphenyl phosphate) (RDP) and the oligomers derived therefrom, and also bisphenol A bis(diphenyl phosphate) (BDP) and the oligomers derived therefrom, and moreover organic and inorganic phosphonic acid derivatives and their salts, organic and inorganic phosphinic acid derivatives and their salts, in particular metal dialkylphosphinates, such as aluminium tris[dialkylphosphinates] or zinc bis[dialkylphosphinates], and moreover red phosphorus, phosphites, hypophosphites, phosphine oxides, phosphazenes, melamine pyrophosphate and mixtures of these. Nitrogen compounds that can be used are those from the group of the allantoin derivatives, cyanuric acid derivatives, dicyandiamide derivatives, glycoluril derivatives, guanidine derivatives, ammonium derivatives and melamine derivatives, preferably allantoin, benzoguanamine, glycoluril, melamine, condensates of melamine, e.g. melem, melam or melom, or compounds of this type having a higher condensation level and adducts of melamine with acids, e.g. with cyanuric acid (melamine cyanurate), with phosphoric acid (melamine phosphate) or with condensed phosphoric acids (e.g. melamine polyphosphate). Examples of suitable synergists are antimony compounds, in particular antimony trioxide, sodium antimonate and antimony pentoxide, zinc compounds, e.g. zinc borate, zinc oxide, zinc phosphate and zinc sulphide, tin compounds, e.g. tin stannate and tin borate, and also magnesium compounds, e.g. magnesium oxide, magnesium carbonate and magnesium borate. Materials known as carbonizers can also be added to the flame retardant, examples being phenol-formaldehyde resins, polycarbonates, polyphenyl ethers, polyimides, polysulphones, polyether sulphones, polyphenylene sulphides, and polyether ketones, and also antidrip agents, such as tetrafluoroethylene polymers.

In another alternative preferred embodiment, the polymer molding compositions to be used for the production of the components of the invention, of hybrid design, can also comprise, if appropriate, in addition to components A) and B) and C) and, if appropriate, D), or instead of D),
E) from 0.001 to 10 parts by weight, preferably from 0.05 to 3 parts by weight, particularly preferably from 0.1 to 0.9 part by weight, of other conventional additives.

For the purposes of the present invention, examples of conventional additives are stabilizers (e.g. UV stabilizers, heat stabilizers, gamma-ray stabilizers), antistatic agents, flow aids, mold-release agents, further fire-protection additives, emulsifiers, nucleating agents, plasticizers, lubricants, dyes, pigments, additives for increasing electrical conductivity and compatibilizers. The additives mentioned and further suitable additives are described by way of example in Gächter, Müller,Kunststoff-Additive [Plastics Additives], 3rd Edition, Hanser-Verlag, Munich, Vienna, 1989 and in Plastics Additives Handbook, 5th Edition, Hanser-Verlag, Munich, 2001. The additives may be used alone or in a mixture, or in the form of masterbatches.

Examples of stabilizers which may be used are sterically hindered phenols, hydroquinones, aromatic secondary amines, e.g. diphenylamines, substituted resorcinols, salicylates, benzotriazoles and benzophenones, and also various substituted representatives of these groups and mixtures thereof.

Examples of pigments and dyes which may be used are titanium dioxide, zinc sulfide, ultramarine blue, iron oxide, carbon black, phthalocyanines, quinacridones, perylenes, nigrosin and anthraquinones.

Examples of nucleating agents which may be used are sodium phenylphosphinate or calcium phenylphosphinate, aluminum oxide, silicon dioxide, and also particularly preferably talc.

Examples of lubricants and mold-release agents which may be used are ester waxes, pentaerythritol tetrastearate (PETS), long-chain fatty acids (e.g. stearic acid or behenic acid) and esters, salts thereof (e.g. Ca stearate or Zn stearate), and also amide derivatives (e.g. ethylenebisstearylamide) or montan ester waxes, and also low-molecular-weight polyethylene waxes and polypropylene waxes.

Examples of plasticizers which may be used are dioctyl phthalate, dibenzyl phthalate, butyl benzyl phthalate, hydrocarbon oils, N-(n-butyl)benzenesulfonamide

Additives which can be added to increase electrical conductivity are carbon blacks, conductivity blacks, carbon fibrils, nanoscale graphite fibers and carbon fibers, graphite, conductive polymers, metal fibers, and also other conventional additives. Nanoscale fibers which can preferably be used are those known as “single-wall carbon nanotubes” or “multiwall carbon nanotubes” (e.g. from Hyperion Catalysis).

Compatibilizers used are preferably thermoplastic polymers having polar groups, e.g. a terpolymer of styrene and acrylonitrile in a ratio by weight of 2.1:1 comprising 1 mol % of maleic anhydride.

Compatibilizers are particularly used when the molding composition comprises graft polymers as described above in the context of component C).

The resultant preferred combinations of the components in polymer molding compositions for use in components of hybrid design are, according to the invention:

A,B,C; A,B,C,D; A,B,C,E; A,B,C,D,E;

A feature of the lightweight components of hybrid design produced according to the invention from the polyamide molding compositions used is relatively high impact resistance at the same time as improved behavior when subject to mechanical and/or thermal load, in comparison with moldings composed of molding compositions of comparable melt viscosity not produced from linear, unbranched semicrystalline polyamides. By virtue of the unusually high modulus of elasticity of about 19 000 MPa at room temperature when linear, unbranched, semicrystalline polyamide is used as component A) in combination, for example, with a core-shell acrylate rubber as component C), the content of glass fibers can be doubled from usually 30% by weight to markedly more than 60% by weight, leading to doubled stiffness of a component of hybrid design produced therefrom, without any impermissible reduction in the toughness of the material. The increase in the density of the polymer molding composition here is only about 15-20%. This permits a marked reduction in the wall thicknesses of the components for identical mechanical performance with markedly reduced manufacturing costs. Astoundingly, this method can be used to produce, for example for the motor vehicle sector, lightweight components whose wall thicknesses are below 3 mm, preferably below 2.5 mm, particularly preferably below 2 mm, without any resultant loss of the properties demanded according to the invention in respect of ability to withstand mechanical and/or thermal load.

For the purposes of the present invention, the term “securely connected” means that thermoplastic material, i.e. the polyamide molding compositions with the fibers located therein, is forced by way of example through apertures in the parent body and flows out on the opposite side of the opening over its edges, to give a secure interlock bond on solidification. However, this can also take place in an additional operation, in that flash material protruding by way of openings is again subjected to mechanical working with a tool in such a way as to produce a secure interlock bond. The term “securely connected” also includes subsequent incorporation by adhesion using adhesives or using a laser. However, the secure interlock bond can also be achieved via flow around the parent body.

In order to obtain a particularly good interlock bond between a parent body composed of fiber-reinforced plastics material and the thermoplastic material with the chopped fibers located therein, in one embodiment of the invention, the thermoplastic is to some extent forced into the fiber-reinforced plastics material of the parent body. This gives an interlocking bond between the thermoplastic and the fibers of the fiber-reinforced plastics material. This type of bond is particularly secure. That portion of the thermoplastic that has not been forced into the material then forms by way of example a functional element or a reinforcement, thus attached in an improved manner to the fiber-reinforced plastics material.

When the thermoplastic material with the chopped fibers located therein is to some extent forced into the polyamide of the fiber-reinforced plastics material, the latter is softened or liquefied. The thermoplastic is molded on at one side of the fiber-reinforced plastics material in such a way that a portion of the other plastics material is forced out from the opposite side. The molded-on thermoplastic thus passes between the fibers of the fiber-reinforced plastics material. The result is not only an adhesive or welded bond but also an interlock bond between the molded-on thermoplastic material and the fiber-reinforced plastics material of the parent body.

In one embodiment of the invention, an interlocking bond is produced between the molded-on thermoplastic material and the fiber-reinforced plastics material only at some points. It is technically simple to achieve bonding only at some points, specifically via conventional injection molding.

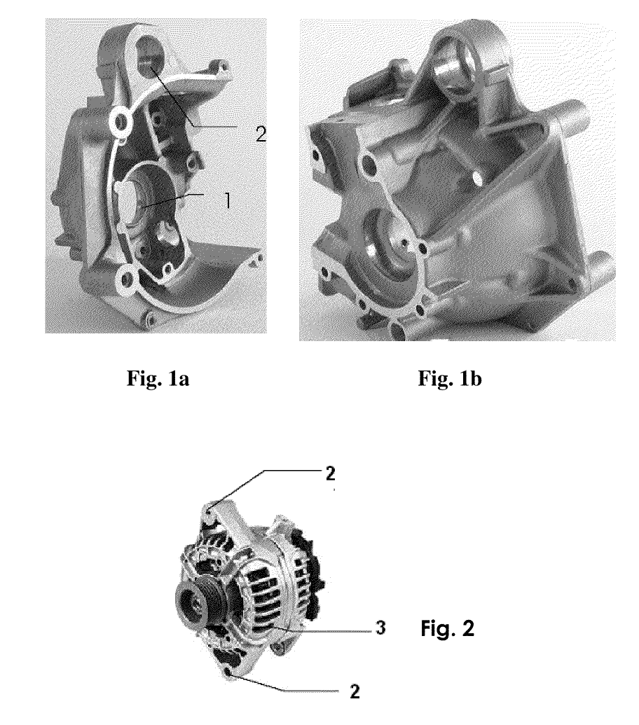

FIGS. 1a and 1b show a shell serving as part of a casing for a generator. A bearing (end plate) 1 for the axis of the rotor can be seen inter alia. An element 2 is present, serving to secure the generator to the vehicle. The shell also comprises relatively complex structures. These further elements of complex structure assume various functions.

FIG. 2 shows another generator with a relatively large casing composed of two shells. Securing elements 2 can be seen inter alia, these being used to secure the generator within the, or on the, vehicle. The generator shown in FIG. 2 also has slits 3, serving for the cooling of the generator.

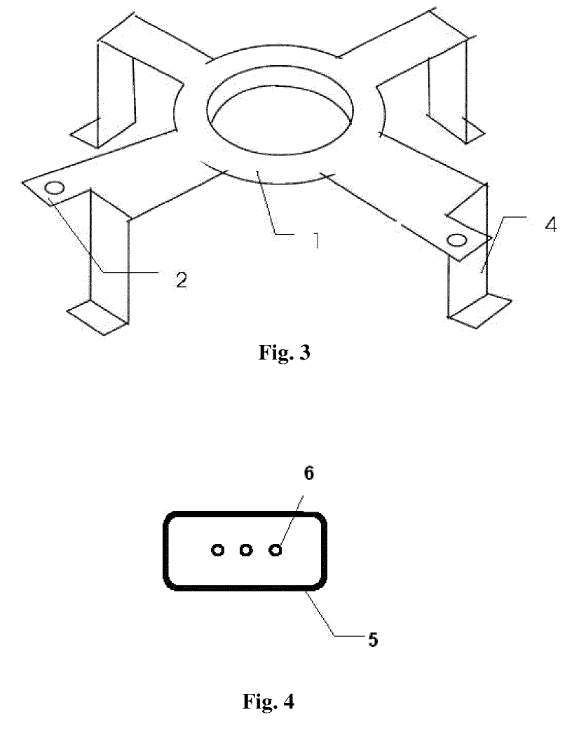

FIG. 3 shows an example of a parent body intended for a generator casing. The parent body is composed of a steel sheet of thickness 1 mm The circular area 1 with protruding section forms a bearing for the axle of the rotor. Elements 2 have been provided in the form of securing lugs which serve for securing the generator to the vehicle. Four arms 4 with peripheral flanges are present and extend from the bearing 1 to the opposite periphery of the shell of the generator casing. The parent body is thus restricted to those elements which are subject to particularly high mechanical load in the generator.

The illustrations show that there are many different applications available to the polymer molding compositions of the invention, preferably in motor vehicles in rail vehicles, in aircraft, in ships, in sleds, or in other means of conveyance, where structures have to be light but stable, or else in the non-automotive sector in electrical or electronic equipment, in household equipment, in furniture, in heaters, in motor scooters, in shopping trolleys, in shelving, in staircases, in escalator steps, in manhole covers, in generators, or in electric motors.

The components used in motor vehicles are preferably complete front ends, headlamp frames, pedestrian-protection beam, specialized slam panels for engine hoods or luggage-compartment lids, front roof arches, rear roof arches, roof frames, roof modules, sliding-roof support parts, dashboard support parts, cross car beam, steering column retainers, fire wall, pedals, pedal blocks, gear-shift blocks, A, B, or C columns, B-column modules, longitudinal members, jointing elements for the connection of longitudinal members and B columns, jointing elements for the connection of A column and transverse member, jointing elements for the connection of A column, transverse member, and longitudinal member, and of transverse members, and wheel surrounds, wheel-surround modules, crash boxes, rear ends, spare-wheel recesses, engine hoods, engine covers, engine oil sumps, gearbox oil sumps, oil modules, water-tank assembly, engine-rigidity systems, front-end rigidity system, chassis components, vehicle floor, door sills, door-sill-reinforcement systems, floor reinforcement systems, seat-reinforcement system, transverse seat members, tailgates, frames, seat structures, backrests, seat shells, seat backrests with or without integrated safety belt, parcel shelves, valve covers, end-shields for generators or electric motors, or the complete vehicle-door structures.

### EXAMPLES

### Example of Particularly Preferred Embodiment

The parent body was overmolded with thermoplastic material comprising linear, unbranched, semicrystalline polyamide, which comprises 62% by weight of glass fibers (component B)=CS 7928 chopped glass fibers from LANXESS N.V., Antwerp). The lengths of the glass fibers in the molding composition were from 500 to 20 μm, their diameter being about 11 μm. The polyamide used was linear, unbranched, semicrystalline nylon-6 with a relative solution viscosity of 2.4 (5% strength m-cresol solution at 25° C.). The thermoplastic material also comprised the following additions:
2% by weight of Paraloid® EXL 3300 (core-shell acrylate rubber from Rohm & Haas), as component C)
100 ppm of Mikrotalk as nucleating agent, component E)
0.09% of carbon black as colorant, component E)
0.09% of Licowax® E Fl (montan ester wax from Clamant) as mold-release agent.

An injection-molding process was used for interlock bonding of the thermoplastic material to the parent body. The thermoplastic material formed the functional elements, for example those shown in FIGS. 1 and 2. The thermoplastic material also particularly stabilized the edges of the parent body. Undesired buckling at the edges of the parent body was thus avoided in particular under dynamic load. The thermoplastic material also particularly helped to improve the acoustic properties of a generator in comparison with a generator with casings composed of metal. The casing was lighter than a casing composed of metal. The hybrid component could in particular be manufactured at lower cost in comparison with casings composed of metal or of specialty plastics which are in particular capable of withstanding thermal and mechanical load.

FIG. 4 shows a plan view of a cover with a periphery 5 and with holes 6 passing through the middle of the cover. The cover is secured with the aid of bolts passing through the holes 6. This type of fastening saves a large number of bolts in comparison with cases where the bolts pass through holes in an arrangement distributed over the periphery 5. In the fastening embodiment shown in FIG. 4, the material of the cover is exposed to more stringent mechanical requirements, however. It has to be resistant to creep, in order to ensure sealing over a long period. The component produced with a polymer molding composition of the invention based on linear, unbranched, semicrystalline polyamide, satisfies this requirement, even when exposed to thermal load. It is therefore possible, by way of example, to manufacture the cover for a cylinder head from the material of the invention, even if the holes are not in an arrangement distributed across the periphery but pass through the center of the cover, thus saving bolts and consequently weight.

1. A lightweight component composed of a shell-type parent body whose external and/or internal space has reinforcing structures securely connected to the parent body and composed of molded-on thermoplastics, and having connection to the parent body at discrete connection sites, wherein said molded-on thermoplastics are formed from polymer molding compositions comprising
A) from 55 to 10 parts by weight of a linear, unbranched, semicrystalline polyamide;
B) from 48 to 80 parts by weight of at least one filler, and
C) from 0.01 to 10 parts by weight of at least one elastomeric modifier

2. The lightweight component as claimed in claim 1, wherein said polyamide comprises nylon-6 or nylon-6,6 with a relative solution viscosity of from 2.3 to 2.7, measured in m-cresol

3. The lightweight component as claimed in claim 1, wherein the polymer molding compositions also comprise, in addition to components A), B) and C),
D) from 0.001 to 30 parts by weight of at least one flame-retardant additive, and/or
E) from 0.001 to 10 parts by weight of other conventional additives.

4. The lightweight component as claimed in claim 1, wherein component B) comprises chopped glass fibers.

5. The process for the production of a lightweight component in hybrid form whose external and/or internal space has reinforcing structures securely connected to the parent body and are composed of a molded-on thermoplastic having connection to the parent body at discrete connection sites, wherein said reinforcing structures are formed of polymer molding compositions comprising
A) from 55 to 10 parts by weight of a linear, unbranched, semicrystalline polyamide,
B) from 48 to 80 parts by weight of at least one filler, and
C) from 0.01 to 10 parts by weight of at least one elastomeric modifier
which are processed via shaping processes in a shaping mold.

6. Motor vehicles, rail vehicles, aircraft, ships, sleds, and other means of conveyance, where structures have to be light but stable, nonautomotive electrical or electronic equipment, household equipment, furniture, heaters, motor scooters, shopping trolleys, shelving, staircases, escalator steps, manhole covers, generators, and electric motors comprising the lightweight components of claim 1.

7. Vehicle parts, load-bearing elements of office machinery, household machinery, or other machinery, and structural elements for decorative purposes comprising the lightweight components of claim 1.

8. The Motor vehicles of claim 6, wherein the lightweight components are used for complete front ends, headlamp frames, pedestrian-protection beam, specialized slam panels for engine hoods or trunk lids, front roof arches, rear roof arches, roof frames, roof modules, sliding-roof support parts, dashboard support parts, cross car beam, steering column retainers, fire wall, pedals, pedal blocks, gear-shift blocks, A, B, or C columns, B-column modules, longitudinal members, jointing elements for the connection of longitudinal members and B columns, jointing elements for the connection of A column and transverse member, jointing elements for the connection of A column, transverse member, and longitudinal member, and of transverse members and for wheel surrounds, wheel-surround modules, crash boxes, rear ends, spare-wheel recesses, engine hoods, engine covers, engine oil sumps, gearbox oil sumps, oil modules, water-tank assembly, engine-rigidity systems, front-end rigidity system, chassis components, vehicle floor, door sills, door-sill-reinforcement systems, floor reinforcement systems, seat-reinforcement system, transverse seat members, tailgates, frames, seat structures, backrests, seat shells, seat backrests with or without integrated safety belt, parcel shelves, valve covers, end-shields for generators or electric motors, or the complete vehicle-door structure.

9. A method for reducing the weight of components or of vehicles of any type, which comprises forming said components or components used in said vehicles of of a shell-type parent body whose external and/or internal space has reinforcement structures securely connected to the parent body and composed of molded-on thermoplastics, and having connection to the parent body at discrete connection sites, and being formed of polymer molding compositions comprising
A) from 55 to 10 parts by weight of a linear, unbranched, semicrystalline polyamide,
B) from 48 to 80 parts by weight of at least one filler, and
C) from 0.01 to 10 parts by weight of at least one elastomer c modifier.

10. The process as claimed in claim 5, wherein the shaping process used comprises injection molding, melt extrusion, compression molding, stamping, or blow molding.
